(19) United States
(12) Patent Application Publication
(10) Pub. No.: US 2009/0019241 A1
(43) Pub. Date: Jan. 15, 2009

(54) STORAGE MEDIA STORING STORAGE CONTROL PROGRAM, STORAGE CONTROLLER, AND STORAGE CONTROL METHOD

(75) Inventors: Kazutaka Ogihara, Kawasaki (JP); Yoshihiro Tsuchiya, Kawasaki (JP); Masahisa Tamura, Kawasaki (JP); Tetsutaro Maruyama, Kawasaki (JP); Kazuichi Oe, Kawasaki (JP); Takashi Watanabe, Kawasaki (JP); Tatsuo Kumano, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/169,311

(22) Filed: Jul. 8, 2008

(30) Foreign Application Priority Data
Jul. 13, 2007 (JP) 2007-183992

(51) Int. Cl. G06F 12/02

(52) U.S. Cl. 711/154; 711/E12.002

(57) ABSTRACT

A computer to runs access control to a plurality of storage areas by;

(a) receiving write data,
(b) reconfiguring the received data as split data by separating each byte of the received data into a plurality of bits, and
(c) instructing writing the split data into a plurality of different storage areas.

### TECHNICAL FIELD

The present invention relates to a storage medium storing a program to distribute and record data to a plurality of storage media, a storage controller, and a method to control storage.

### BACKGROUND

Network storage systems are available that control a disk connected to a network. Other network storage systems control a plurality of disks in order to support mass storage and improve reliability.

Japanese Laid-open Patent Publication No. 2005-135116 describes a storage device which can improve storing efficiency by separating a physical storage area into physical blocks of certain unit length, and storing identification information of the data placement pattern so that write request data for each physical block matches a pre-registered data placement pattern. Japanese Laid-open Patent Publication No. 2001-337850 discloses a storage device which can improve storing efficiency of logical devices within a physical device by separating and managing a storage area, which is included in a plurality of physical devices, into storage units such as sectors, and reallocating the stored data by storage unit. However, data stored in the disk can still be readable. Therefore, the data is possibly read if the physical storage device is stolen, or taken out for repair.

### SUMMARY

According to the following embodiments, an access control program stored in a storage media causes a computer to:

(a) receive a write data;
(b) reconfigure the received data as split data by separating each byte of the received data into a plurality of bits; and
(c) instruct the computer to write the split data into a plurality of different storage areas.

### BRIEF DESCRIPTION OF THE DRAWINGS

FIG. 1 is a block diagram illustrating one example of a generic storage configuration according to technology used by the embodiments;

FIG. 2 is a block diagram illustrating one example of a storage configuration according to the first embodiment;

FIG. 3 is a block diagram illustrating one example of a storage configuration of an access processor (AP) according to the first embodiment;

FIG. 4 is a flow chart illustrating a series of operations to write data using the AP according to the first embodiment;

FIG. 5 is a diagram illustrating one example of operation of a processing pattern A according to the first embodiment;

FIG. 6 is a diagram illustrating one example of operation of a processing pattern B according to the first embodiment;

FIG. 7 is a table showing one example of a replacement setting according to the first embodiment;

FIG. 8 is a table showing one example of a reconfiguration setting according to the first embodiment;

FIG. 9 is a flow chart illustrating one example of a data reading operation by the AP according to the first embodiment; and

FIG. 10 is a figure illustrating one example of a conversion process operation according to the second embodiment.

### DETAILED DESCRIPTION OF THE EMBODIMENTS

Technology based on the present information is explained below. First, an overview of a generic storage system having a number of autonomously operating controllers is explained.

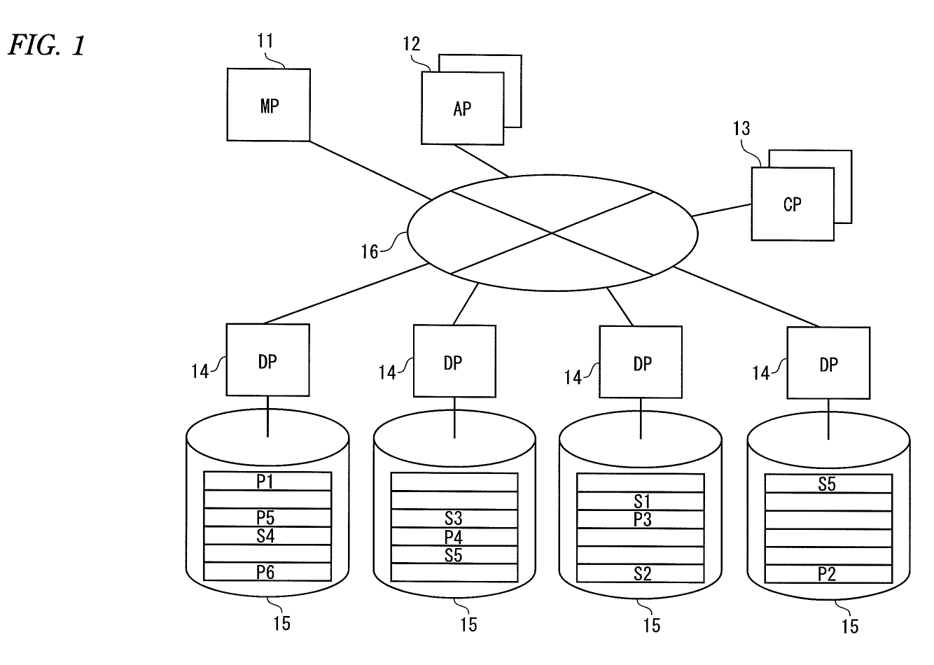

FIG. 1 is a block diagram illustrating one example of the generic storage configuration used by the present embodiment. The generic storage includes Management Processor (MP) 11, Access Processor (AP) 12, Control Processor (CP) 13, Data Processor (DP) 14, Disk 15, and Network 16. The MP 11, the AP 12, the CP 13, and the DP 14 indicate computers, and are connected respectively via the Network 16. The disk 15 is connected to the DP 14. A plurality of disks 15 can be connected to the DP 14.

The MP 11 is a computer from which the administrator issues commands to manage the generic storage system. The AP 12 is a computer that receives requests from a user and transmits the requests to the DP 14. The CP 13 manages logical volume information and monitors the state of the DP 14.

The user transmits a request to the storage by accessing logical volume of the AP 12. The DP14 receives and processes requests on writing and reading data sent by the AP12. Moreover, data is sent and received among the DP 14's in order to configure and restore data duplication.

Logical volume is segmented and managed in terms of a certain size (e.g. 1 GB). The DP14 separates the disk 15 connected to the DP 14 into slices (storage area) which are the same size as the segments. All segments are duplicated and a pair of slices is assigned. Slices include primary, secondary and other slices. The primary data of the duplicated segments is stored in primary slices while that of the secondary data is stored in the secondary slice.

In this example, each disk 15 has 6 slices. P1, P2, P3, P4, P5, and P6 indicate the primary slices, while S1, S2, S3, S4, S5 and S6 indicate the secondary slices respectively. Numbers assigned to the primary slices and the secondary slices indicate segment numbers and when the primary slices and the secondary slices have identical segment numbers such as P1 and S1, it means that the primary slices and the second slices are duplicates.

The DP 14 retains metadata regarding logical volume and slices. The CP 13 captures metadata from all of the DP 14's and retains them. When the logical volume is changed or any malfunction is detected at one of the DP 14's, the CP 13 transmits an instruction to change the metadata in the sibling DP14 that stores a mirror image of the data in the changed or disabled DP14. For example, the DP14 that stores the data in the disk area S1 is the sibling of the DP14 that stores the data in the disk area P1, because S1 and P1 store mirror images of.

At data writing, a user's computer transmits a write request and the data to the AP 12. Then the AP12 splits the data into a defined unit and transmits the write request to the DP 14. The DP 14 which received the write request identifies the other DP 14 to which duplication should be applied based on the logical volume information and transmits the write request to the DP 14. The DP 14 which received the write request from the AP 12 is called the primary DP and the other DP 14 which received the write request from the primary DP is called the secondary DP.

The secondary DP which received the write request schedules writing of the data to the disk 15 under management of the secondary DP, and transmits a response to the primary DP. The AP 12 which received the response from the primary DP transmits a response to the user's computer which issued the write request.

When reading the data, the user's computer transmits a read request to the AP 12. The AP 12 transmits the read request to the DP 14 to which the primary data was written. The DP 14 which receives the read request from the AP 12 then reads the data from the Disk 15 managed by the DP14, and transmits the data to the AP 12. The AP 12 which receives the data reconfigures the data and transmits the data to the user's computer.

When the initialized DP 14 is added to the network, the new DP14 transmits “life information as information that shows working DP14” to the CP13. The CP 13 which received the life information inquires to the newly added DP 14 for logical volume information. The new DP 14 transmits its the logical volume information to the CP 13. The CP 13 incorporates the information in its logical volume information and this enables the CP13 to use the Disk 15 managed by the new DP14 as part of logical volume of the storage system.

When an administrator executes a command at the MP 11 to remove any DP 14, the data is duplicated so that the duplicated data configuration is not lost. The CP 13 calculates the disk space for the overall system and instructs the DP 14 to be removed and another DP 14 to duplicate the data so that the duplicated data does not exist in the same DP 14. After completing the duplication process and the reconfiguration, the DP 14 can be removed from the network.

When usage of each DP14 is non-uniform as a result of maintenance such as addition or replacements of DP 14, accesses are concentrated on specific DP14's, thereby deteriorating the performance of the storage system, and data duplication will be difficult when one of the DP14's fails. In order to solve these problems, a data reallocation function is provided to average usage of each DP 14. When an administrator executes a command at the MP 11 to reallocate data, the CP 13 inquires to the DP 14's for usage information, and instructs appropriate data movement so that the usage will be averaged.

When the DP14 fails, data duplication is lost. In this case, the storage system automatically runs recovery and restores the data duplication configuration. The CP13 performs so-called heart beat communication to all of the DP 14's. The CP 13 detects a failure of one of the DP 14's when the heart beat communication with the DP 14 is lost or the received heart beat communication has error information.

When the CP 13 determines that a certain DP 14 has failed, the CP 13 identifies which data requires restoring duplication based on the retained logical volume information. Then the CP 13 secures space in another DP 14 for reduplicating the data. The CP 13 instructs the other DP14 having the data in the failed DP 14 to duplicate the unduplicated data in a DP 14 with sufficient space. The DP 14 which received the instruction duplicates the data according to the instruction, reconfigures the duplex information, and completes the recovery.

However, data within slices may be readable in the above mentioned generic storage system. Therefore, the data can possibly be read if the physical storage device is stolen, or taken out for repair.

Preferred embodiments of the present invention will be explained by referring to the accompanying drawings.

### The First Embodiment

The first embodiment is explained for generic storage systems to which storage controller of the present invention is applied.

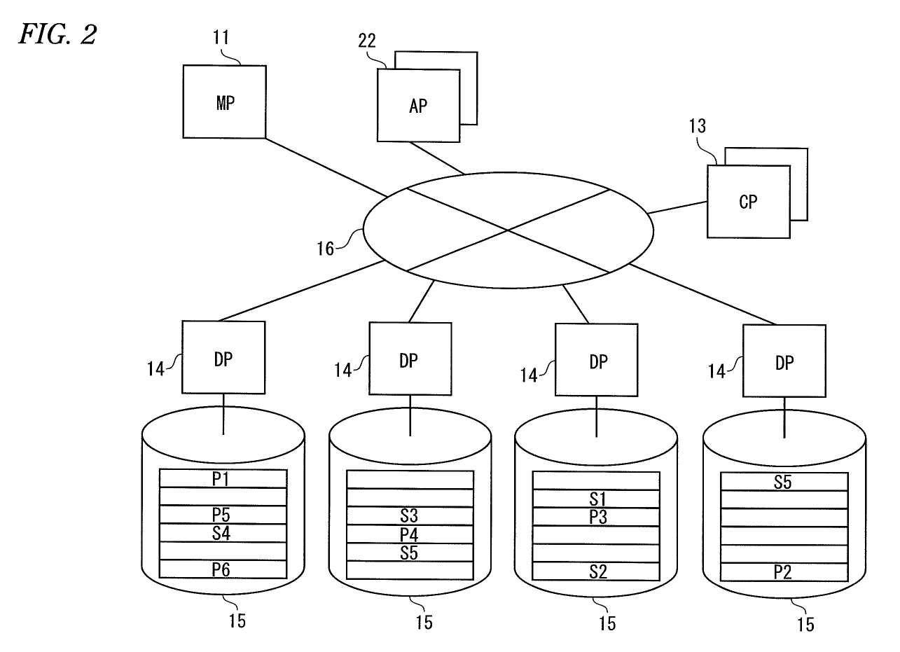

FIG. 2 is a block diagram illustrating one example of a generic storage configuration used with the present invention. When a name in FIG. 2 is the same as that in FIG. 1, the two are the same or equivalent components. Therefore repetitive explanations for these components will be omitted. For example, FIG. 2 when compared with FIG. 1 includes AP 22 (storage controller) instead of the AP 12.

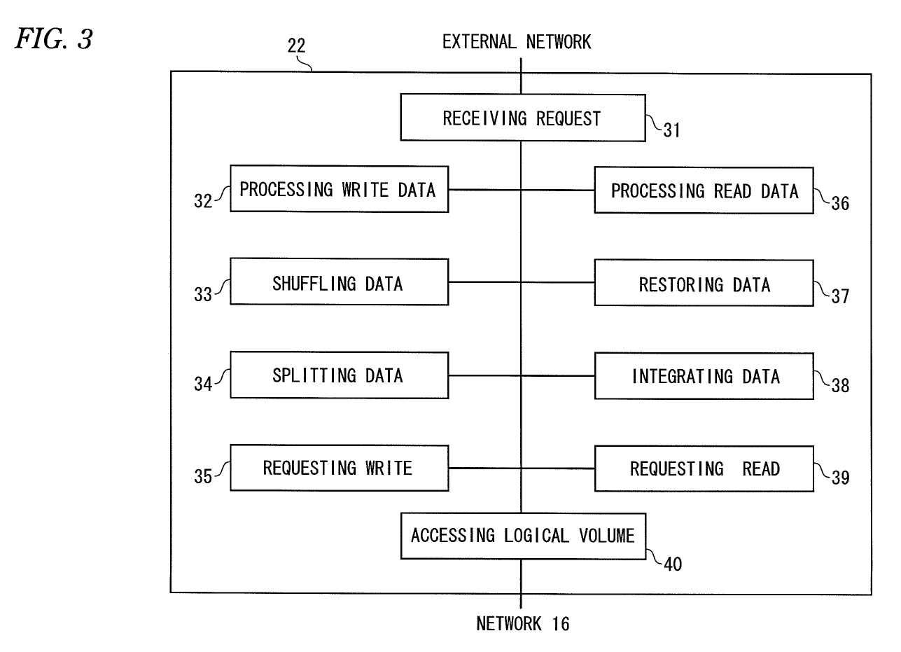

FIG. 3 is a block diagram illustrating one example of a storage configuration of an AP according to this embodiment. The AP22 includes: a receiving request unit 31, processing “write data” unit 32, a data shuffling unit 33, a data splitting unit 34, a writing request unit 35, processing “read data” unit 36, a data restoring unit 37, a data integration unit 38, a read request unit 39, and an accessing logical volume unit 40 connected as shown by a bus. The request receiving unit 31 is connected to an external network from where a request for storage is transmitted. The logical volume accessing unit 40 is connected to the network 16.

Next, operations of writing data at AP 22 according to this embodiment are explained.

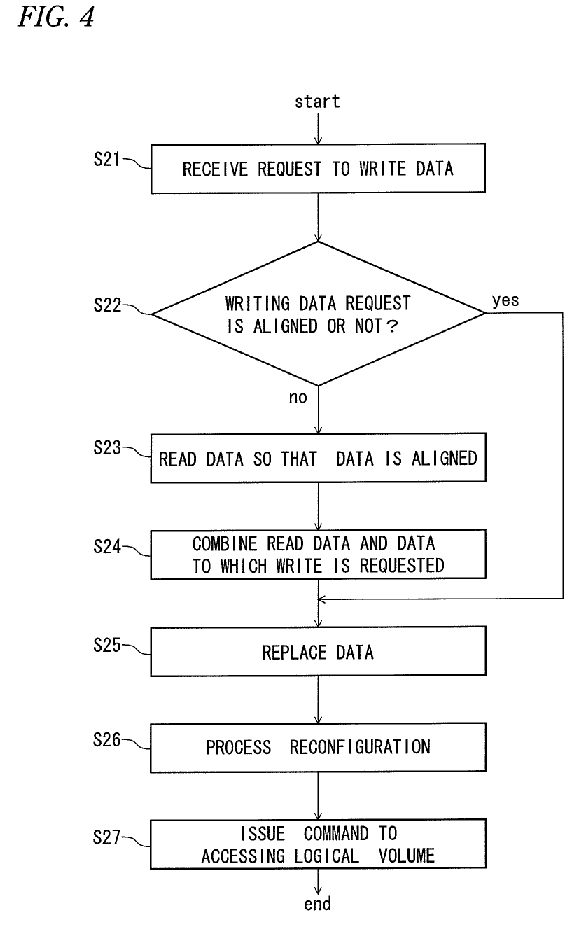

FIG. 4 is a flow chart illustrating a series of operations to write data according to the first embodiment of the present invention. First, when the request receiving unit 31 receives a request to write data (S21), processing “write data” unit 32 determines whether the write data included in the data writing request is aligned or not (S22). The alignment means a byte unit (e.g., two bytes) for processing data.

When write data is aligned (S22, yes), then the process transits to S25. When write data is not aligned (S22, No), processing “read data” unit 36 reads data adjacent to the writing position so that the data is aligned (S23). Then processing “read data” unit 36 combines the read data and data to which write is requested and aligns the combined data (S24). Shuffling data unit 33 replaces data in units of bit (S25). The data splitting unit 34 splits the data in units of byte, and processes the reconfiguration (S26). Based on the reconfigured data, the writing request unit 35 issues a command to the logical volume accessing unit 40, and this completes the flow.

The logical volume accessing unit 40 generates a command to request writing to different slices for each reconfigured data and transmits the command to the DP 14 (storage device) managing slices subject to writing. The DP 14 which received the command executes writing to the disk 15 according to the command.

Details of the replacement process by the data shuffling unit 33 are explained below. Processing Patterns A and B are set as processes for the data shuffling unit 33.

First, processing pattern A is explained. Processing pattern A separates data into alignment of 2 bytes and rotates the alignment 3 bits to the left.

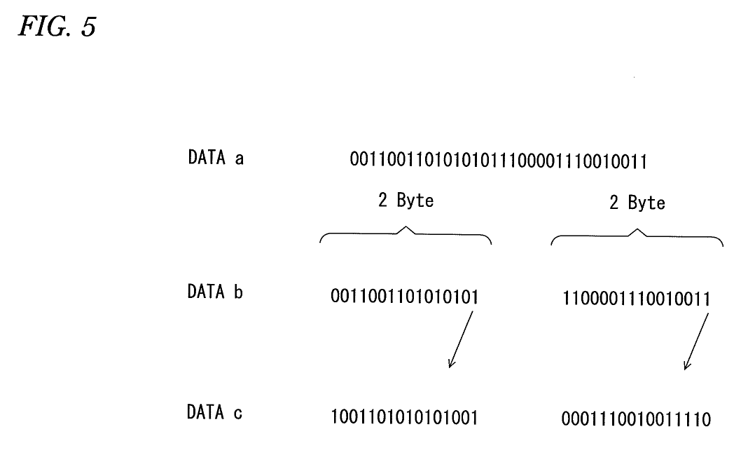

FIG. 5 is a figure illustrating one example of operation of processing pattern A according to the embodiment of the present invention. “DATA a” shows received 4 byte data in bits. “DATA b” shows the data that is separated into 2 byte alignment. “DATA c” shows the result of 3 bit rotation to the left for each “DATA b” alignment.

Next, processing pattern B is explained. Processing pattern B separates data into alignment of 2 bytes, and the alignment is further separated and replaced in units of 4 bits.

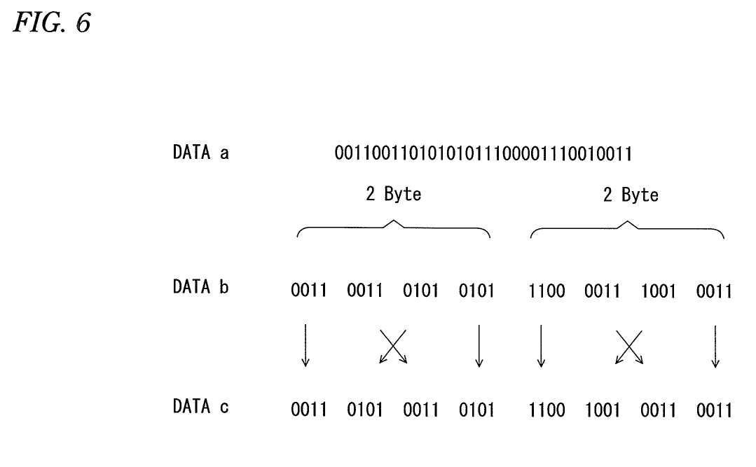

FIG. 6 illustrates one example of operation of processing pattern B according to the embodiment of the present invention. “DATA a” shows received 4 byte data in bits. “DATA b” shows the data separated into 2 byte alignment and further divided into blocks of 4 bits. “DATA c” shows the result of replacing blocks of 4 bits within the alignment of “DATA b”. Here, the second and the third blocks among the four blocks within the alignment are exchanged.

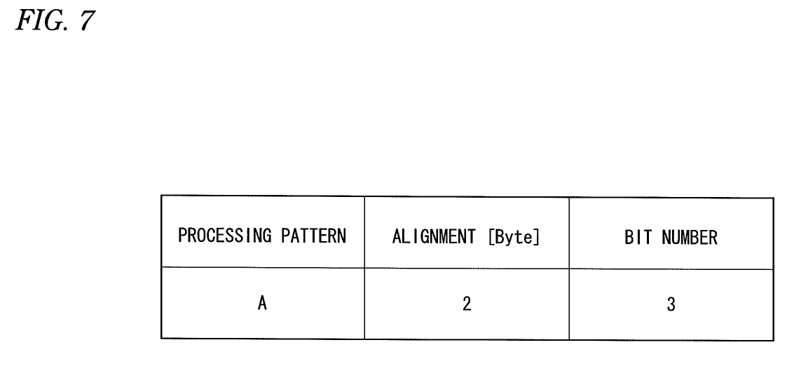

The data shuffling unit 33 provides a replacement setting table in order to set the above mentioned replacement processing. FIG. 7 is one example of reconfiguration setting according to the embodiment of the present invention. The table provides the replacement processing pattern, alignment of replacement processing, and bits value used for replacement processing. The “PROCESSING PATTERN” indicates the above mentioned Pattern A or Pattern B. The “ALIGNMENT” indicates the size of the data chunk (in bytes). The “BIT NUMBER” indicates the number of bits to rotate in Processing Pattern A. The bit number also indicates the number of bits to separate in Processing Pattern B.

Details of the reconfiguration process by the data splitting unit 34 are explained below.

The data splitting unit 34, for example when alignment is 2 bytes, separates each alignment of received data into two parts, generates a plurality of commands, and converts the data access destination of each command. A series of commands that include received data is represented as below.

### COMMAND, B, SIZE, DATA

This COMMAND can be “Read” or “Write”. The “B” indicates that the access is from “B” byte of logical volume. The “SIZE” indicates an access area in units of bytes. The “DATA” in case of “Write” stores the data (replacement by the shuffling data unit 33 has already been completed) that required writing.

For example, A command that included data after replacement are as follows.

Write, 1000, 8, ABCDEFGH

The data splitting unit 34 separates the command into two commands.

Write, b1, s1, ACEG

Write, b2, s2, BDFH

When the size of the logical volume to access is 10,000 bytes, “b1” and “b2” are obtained as below.

b1=B/2=500

b2=B/2+LVOLSIZE/2=5500

### (B=1000, LVOLSIZE=10000)

“s1” and “s2” are obtained as below. The result of division is obtained by rounding down after the decimal point.

$$\begin{matrix}s 1 = ( SIZE + ALIGNMENT - 1 ) / 2 \\ = ( SIZE + 2 - 1 ) / 2 \\ = 4\end{matrix}$$

$$\begin{matrix}s 2 = ( SIZE + ALIGNMENT - 1 ) / 2 \\ = ( SIZE + 2 - 1 ) / 2 \\ = 4\end{matrix}$$

$$( SIZE = 8 , ALIGNMENT = 2 )$$

This means the received data in units of 1 byte is allocated to two different slices.

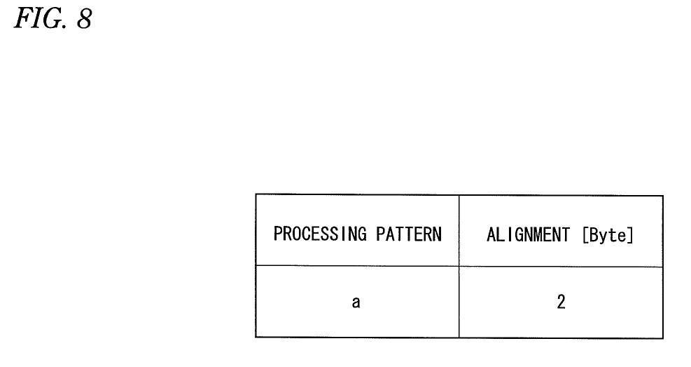

The data splitting unit 34 provides a reconfiguration setting table to set the above mentioned reconfiguration. FIG. 8 is a table illustrating one example of a reconfiguration table according to an embodiment of the present invention. The reconfiguration setting table provides a processing pattern and an alignment value for the reconfiguration process. The “PROCESSING PATTERN” indicates the processing pattern ‘a’ which means the size of the logical volume to access is used by a parameter. The “ALIGNMENT” indicates the size of the data chunk (in bytes) as that of the replacement setting table (FIG. 7).

The write data obtained by the write data request in the above mentioned replacement and reconfiguration processes are split and converted into a plurality of slices of data (split data). Because each byte in the write data is allocated to a plurality of slices of data, the write data cannot be read from the slices stored in one particular storage medium.

The data reading operation by the AP according to the embodiment of present invention is explained below.

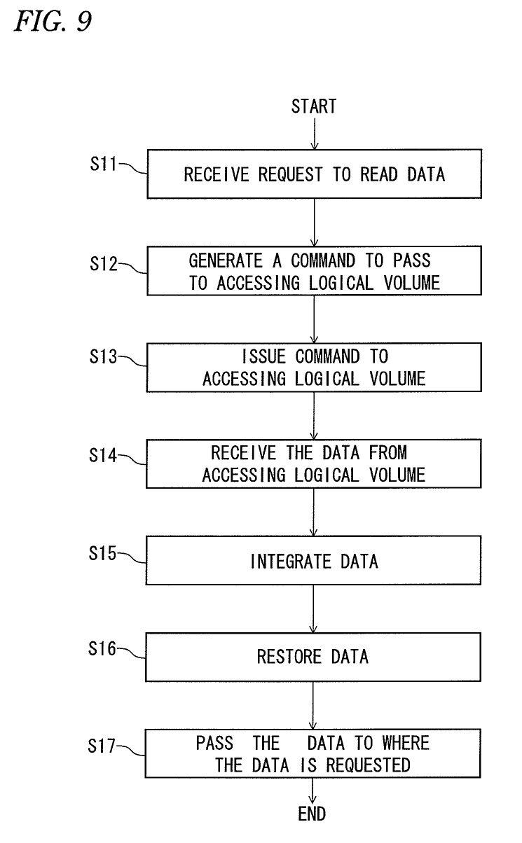

FIG. 9 is a flow chart illustrating one example of an operation of reading data by an AP according to the embodiment of the present invention. First, when the request receiving unit 31 receives a request to read data (S11), processing “read data” unit 36 generates a command to pass to the accessing logical volume unit 40 (S12). Then the read requesting unit 39 issues a command to the logical volume accessing unit 40 (S13). The logical volume accessing unit 40 transmits the command to a selected DP 14. The DP 14 which received the command reads data from its disk 15 by following the command and transmits the read data to the logical volume accessing unit 40.

Then the read requesting unit 39 receives the data from the logical volume accessing unit 40 (S14). The data integrating unit 38 then performs data integration to reconfigure the received data in units of bytes (S15). Then the restoring data unit 37 performs a restoring process to restore data in units of bits based on the reconfigured data (S16). After that, the request receiving unit 31 passes the data to where the data is requested (S17), thereby completing the flow.

The integrating process by the data integrating unit 38 is the reverse of the reconfiguration process by the data splitting unit 34. The restoring process by the data restoring unit 37 is the reverse of the replacement process of the data shuffling unit 33. Data stored after separation into a plurality of slices at writing is restored to the original data by the integrating and restoring processes at the reading stage.

### Second Embodiment

Configuration and operation of the generic storage system according to the second embodiment is similar to that of the first embodiment. However, in the second embodiment, the following conversion process is performed instead of the replacement and reconfiguration processes in the first embodiment.

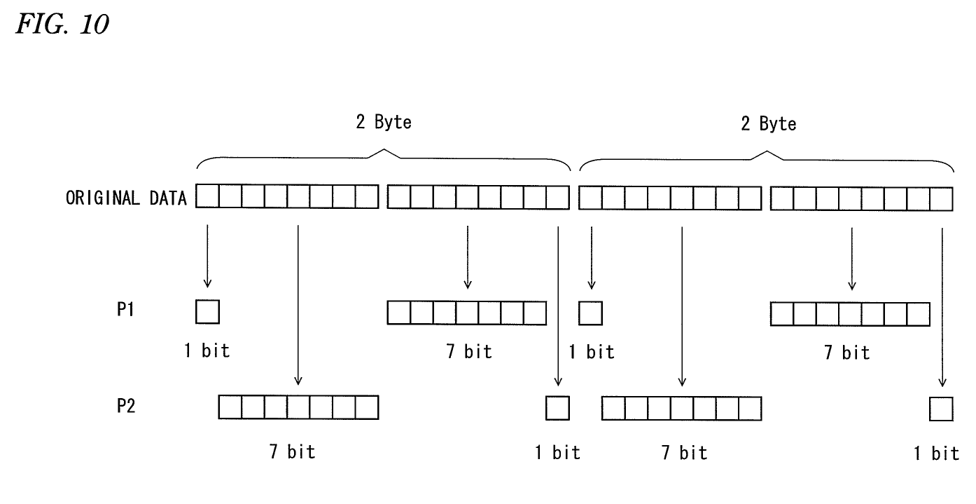

FIG. 10 is a figure illustrating one example of the conversion process operation according to the second embodiment of the present invention. In this example, data is written into two primary slices. P1 indicates the first primary slice, while P2 indicates the second primary slice.

In this example, the AP 22 splits received data into an alignment of 2 bytes. Then the AP 22 extracts the first bit and bits from the ninth to fifteenth positions, and then combines these bits to obtain data to write into P1. On the other hand, the AP 22 extracts bits from the second to eighth and sixteenth positions, and then combines these bits to obtain data to write into P2. This conversion process splits the write data obtained at the data writing request, and converts the data (separated data) to a plurality of slices. Because each byte in the write data is allocated to a plurality of slices of data, the written data cannot be read from only selected slices stored in the storage medium.

Data stored after splitting into a plurality of slices is restored to its original form by performing a process reverse to conversion at reading.

Write data can also be converted into a plurality of split data by preparing and using a table showing the bit position in alignment before conversion and the corresponding split data and bit position in alignment after conversion. Other rules may be used as long as data is written to a plurality of storage media after replacing data in units of 1 byte or less.

According to the above mentioned embodiments, by storing data after encryption and splitting, the meaning of data cannot be determined when the storage media is taken out.

The receiving step corresponds to the receiving request in the embodiment of present invention. The converting step corresponds to shuffling data, splitting data, integrating data, and restoring data. The instructing step corresponds to accessing logical volume in the embodiment of the present invention.

A storage medium can be provided that stores a storage control program controlling computers configured in a storage control device to execute the above mentioned steps. The above mentioned program is enabled to control computers configured in the storage control device by storing the program in a storage media readable by a computer. Such computer readable media include internal memories such as ROM and RAM, a portable memory such as CD-ROM, a flexible disk, DVD disk, a magnet-optical disk, and IC card, and a database which stores computer programs, or other computer, and a database.

What is claimed is:

1. A computer-readable medium storing a storage control program controlling a computer to run access control to a plurality of storage areas by:
receiving write data having a plurality of data bytes, each data byte having a plurality of bits,
write converting each byte of said write data by splitting the bytes into groups and reconfiguring the groups into units of bits; and
writing said each group of reconfigured data to the plurality of storage areas.

2. The computer-readable storage medium storing a storage control program according to claim 1, wherein said plurality of storage areas are managed by at least one storage device, said storage device storing the split data.

3. The computer-readable storage medium storing a storage control program according to claim 1, wherein the sizes of said plurality of storage areas are the same.

4. The computer-readable storage medium storing a storage control program according to claim 1, wherein
said write data is split into blocks of predetermined size, and the bits within said blocks are allocated to said plurality of split data based on the relationship between the bit position within said blocks and said split data.

5. The computer-readable storage medium storing a storage control program according to claim 4, wherein
said converting rotates a bit sequence of said blocks up to a predetermined number of bits,
thereby obtaining converted data,
and splits the converted data to obtain the split data.

6. The computer-readable storage medium storing a storage control program according to claim 4, wherein
said converting replaces the order of bits within said block to obtain converted data and allocates the converted data to said split data.

7. The computer-readable storage medium storing a storage control program according to claim 2, wherein
when a read data request is received;
a read instruction is issued to said storage device managing the storage areas subject to said read request; and
requested read data is obtained by applying a conversion process reverse to said writing converting.

8. A storage controller controlling access to a plurality of storage areas comprising:
receiving write data having a plurality of data bytes, each data byte having a plurality of bits,
write converting said write data by splitting said received write data into a plurality of split data wherein a plurality of bits of each byte of said write data are allocated to said plurality of split data; and
instructing a storage device to write said plurality of split data to the plurality of different storage areas.

9. A storage controller according to claim 8,
wherein said instructing issues a write request to said storage device managing said storage area to store the split data.

10. A storage controller according to claim 8,
wherein the sizes of said plurality of storage areas are the same.

11. A storage controller according to claim 8, wherein
said converting splits said write data into blocks of predetermined size, and a plurality of bits within said blocks are allocated to said plurality of split data blocks based on the relationship between the preset bit position within said blocks and said split data.

12. A storage controller according to claim 11,
wherein said converting rotates the bits of said blocks up to a predetermined number of bit spaces, thereby obtaining converted data, and splits the converted data to obtain the split data.

13. A storage controller according to claim 11,
wherein
said converting replaces the order of bits within said block to obtain converted data and allocates the converted data to said split data.

14. A storage controller according to claim 9,
wherein when a read request is received;
said read request is issued to said storage device managing the storage areas subject to said read request; and
said requested read data is obtained by applying a conversion process reverse to said writing converting.

15. A method to control accesses to a plurality of storage areas comprising:
receiving write data having a plurality of data bytes, each data byte having a plurality of bits;
write converting each byte of said write data into a plurality of split data wherein a plurality of bits of each byte is allocated to different parts of the split data; and
writing said plurality of split data to the plurality of different storage areas.

16. A method to control storage according to claim 15, wherein
said plurality of storage areas are managed by at least one storage device.
